(19) United States
(12) Patent Application Publication
(10) Pub. No.: US 2026/0326847 A1
(43) Pub. Date: Oct. 22, 2026

(54) MOTORCYCLE OPERATION TRAINING APPARATUS

(71) Applicant: William Herbeck, Rosharon, TX (US)

(72) Inventor: William Herbeck, Rosharon, TX (US)

(21) Appl. No.: 19/180,517

(22) Filed: Apr. 16, 2025

(51) Int. Cl. B62H 7/00; G09B 19/16

(52) U.S. Cl. CPC B62H 7/00; G09B 19/167

(57) ABSTRACT

A training apparatus for facilitating a user in training to lean a motorcycle for making turns includes a base and a cradle pivotably coupled to the base. The cradle is pivotable alternately toward a first lateral side and a second lateral side of the base and is shaped and configured to seat a wheel of the motorcycle. A bias assembly is coupled to and extends between the cradle and the base. The bias assembly is configured to bias the cradle toward a central position with respect to the base, wherein the cradle is pivotable against bias alternately toward the first lateral side and the second lateral side of the base from the central position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to motorcycle support apparatuses and more particularly pertains to a new motorcycle support apparatus for facilitating a user in training to lean a motorcycle for making turns.

### (2) Description of Related Art Including Information Disclosed Under 37 CFR 1.97 and 1.98

Various apparatuses of the prior art are described to support a motorcycle to prevent the motorcycle from tipping over. Such devices include structures such as wheels or bumpers which engage with a ground surface to prevent or damp a rotation of the motorcycle that would tip a lateral side of the motorcycle onto the ground surface. However, the prior art fails to describe such an apparatus which cradles one of the wheels of the motorcycle. The prior art also fails to cradle only one wheel such that the other wheel may rest atop the ground surface, thereby allowing a user to train to lean the motorcycle without tipping the motorcycle over as is needed when driving the motorcycle through turns.

### BRIEF SUMMARY OF THE INVENTION

An embodiment of the disclosure meets the needs presented above by generally comprising a base and a cradle pivotably coupled to the base. The cradle is pivotable alternately toward a first lateral side and a second lateral side of the base and is shaped and configured to seat a wheel of a motorcycle. A bias assembly is coupled to and extends between the cradle and the base. The bias assembly is configured to bias the cradle toward a central position with respect to the base, wherein the cradle is pivotable against bias alternately toward the first lateral side and the second lateral side of the base from the central position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use rear view of a training apparatus according to an embodiment of the disclosure.

FIG. 2 is a top view of an embodiment of the disclosure with a cradle of the embodiment removed.

FIG. 3 is a rear view of an embodiment of the disclosure with a cradle of the embodiment removed.

FIG. 4 is a side detail view of a cradle of an embodiment of the disclosure.

FIG. 5 is a rear detail view of a cradle of an embodiment of the disclosure.

FIG. 6 is a top detail view of a cradle of an embodiment of the disclosure.

FIG. 7 is a rear view of an embodiment of the disclosure. A rear portion of a base of the embodiment has been removed to show detail of a bias assembly.

### DETAILED DESCRIPTION OF THE INVENTION

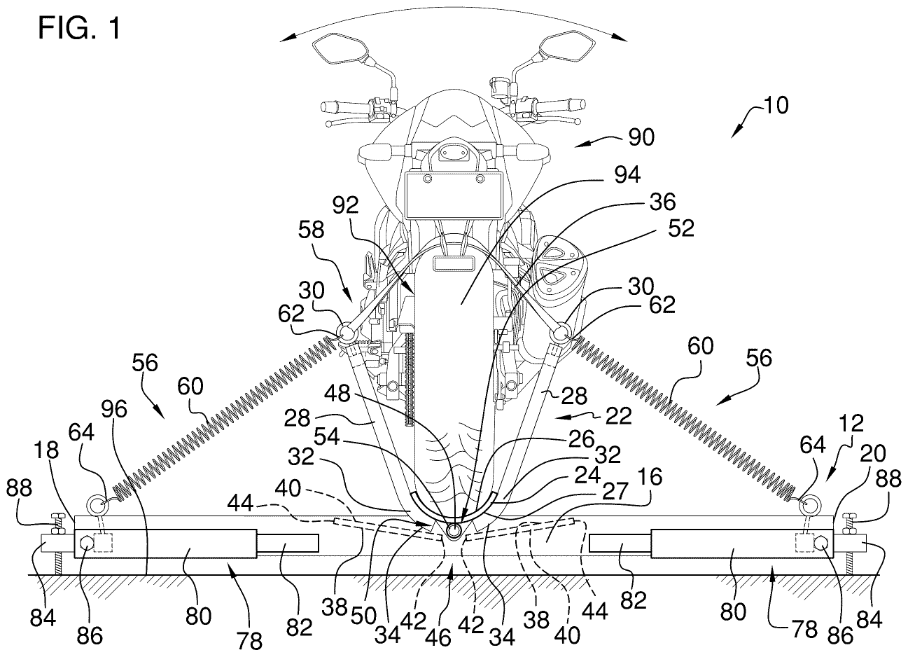

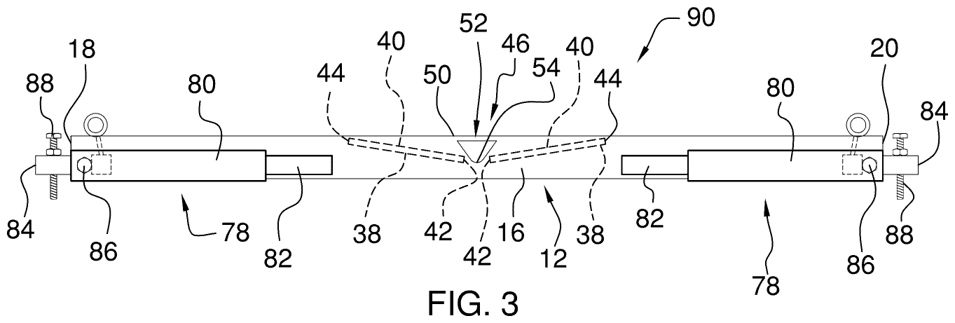

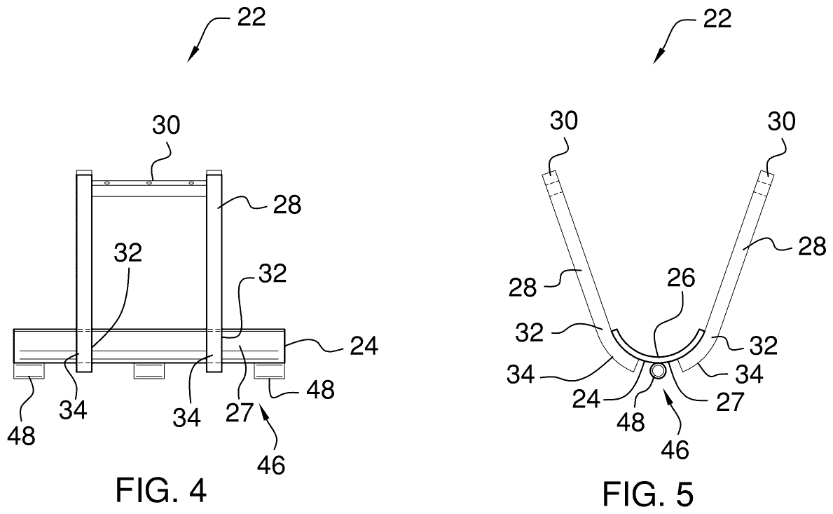

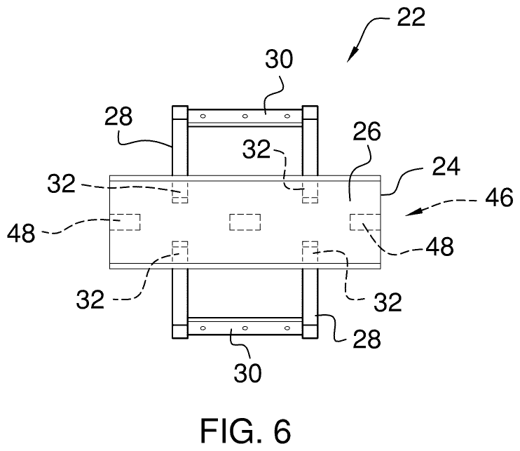

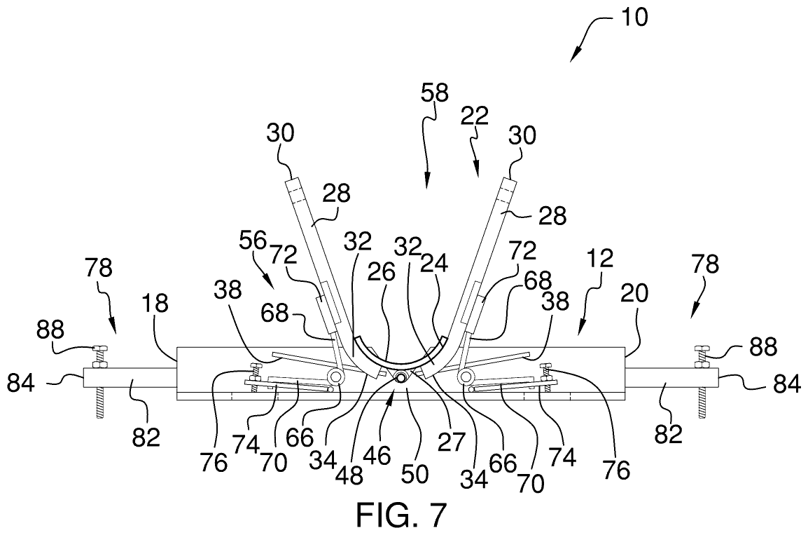

With reference now to the drawings, and in particular to FIGS. 1 through 7 thereof, a new motorcycle support apparatus embodying the principles and concepts of an embodiment of the disclosure and generally designated by the reference numeral 10 will be described.

As best illustrated in FIGS. 1 through 7, the training apparatus 10 generally comprises a base 12 and a cradle 22 pivotably coupled to the base 12 which is shaped to hold a wheel 92 of a motorcycle 90 or other two-wheel 92ed vehicle, such as a moped, a bicycle, or the like. The cradle 22 is pivotable alternately toward a first lateral side 18 and a second lateral side 20 of the base 12. The cradle 22 comprises a platform 24 with an upper surface 26 that may support the wheel 92. The upper surface 26 has a concave shape which is complementary in shape to an exterior of the wheel 92. The cradle 22 further comprises a pair of support arms 28 coupled to the platform 24 and a mounting strap 36 that is coupled to and extends between distal ends 30 of the support arms 28 with respect to the platform 24. The support arms 28 are positioned opposite each other across the platform 24 and extend upwardly and outwardly from the platform 24 in a V-shape. The mounting strap 36 may extend over the wheel 92 to secure the wheel 92 onto the platform 24. The mounting strap 36 may be adjustable in length via a slider, an elastic material, or the like such that the mounting strap 36 may be fitted over the wheel 92 of the motorcycle 90.

Each support arm 28 has a lower segment 32 which extends under the platform 24 and has a rocking surface 34 opposite the platform 24 with a convex shape. A plurality of rocking support members 38 is coupled to the base 12, wherein each rocking support member 38 is positioned under an associated support arm 28 of the pair of support arms 28 of the cradle 22. The rocking surface 34 of each support arm 28 is positioned to rock over an associated rocking support member 38 of the plurality of rocking support members 38 when the cradle 22 is pivoted. A top surface 40 of each rocking support member 38 is angled to extend upwardly from an inner edge 42 to and outer edge 44 of the rocking support member 38.

A pivot mechanism 46 couples the cradle 22 to the base 12. The pivot mechanism 46 comprises a pair of cylindrical rods 48 coupled to the cradle 22 on a lower side 27 of the platform 24, and a pair of rod receivers 50 coupled to the base 12. Each cylindrical rod 48 extends between a front side 14 and a back side 16 of the base 12, and each rod receiver 50 of the pair of rod receivers 50 has an associated cylindrical rod 48 of the pair of cylindrical rods 48 mounted therein. Each rod receiver 50 has an opening 52 for receiving the associated cylindrical rod 48 and a pivot support surface 54 within the opening 52 which is complementary in shape to an exterior of the associated cylindrical rod 48. The opening 52 of each rod receiver 50 is larger than the associated cylindrical rod 48 such that the cylindrical rod 48 may lift off of the pivot support surface 54 when the cradle 22 rocks onto either rocking support member 38.

A bias assembly 56 is coupled to and extends between the cradle 22 and the base 12. The bias assembly 56 is configured to bias the cradle 22 toward a central position 58 with respect to the base 12. The cradle 22 is pivotable against bias alternately toward the first lateral side 18 and the second lateral side 20 of the base 12 from the central position 58.

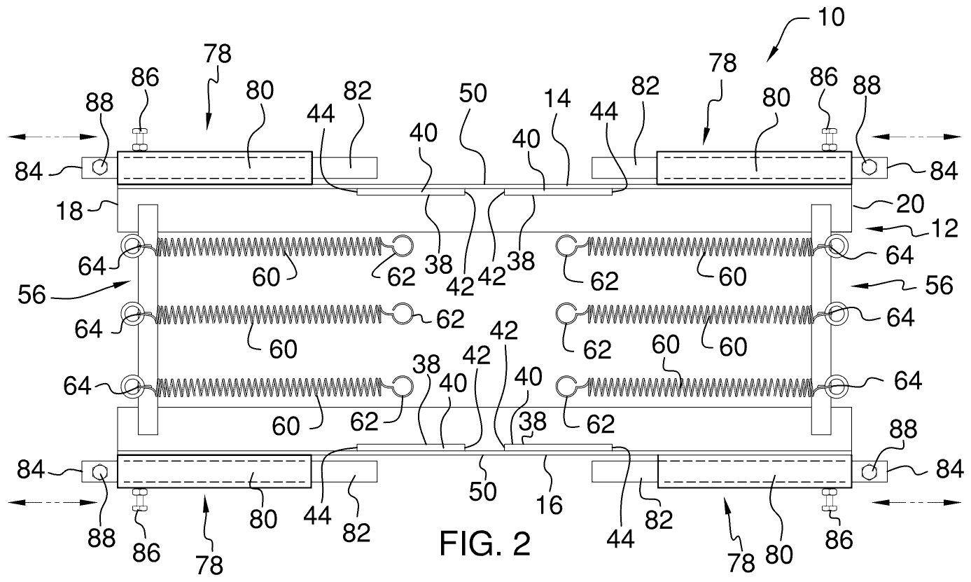

With reference to FIGS. 1 and 2, the bias assembly 56 in one embodiment comprises a plurality of tension springs 60. A first end 62 of each tension spring 60 is coupled to the distal end 30 of an associated support arm 28 of the pair of support arms 28, and a second end 64 of each tension spring 60 is coupled to the base 12 adjacent to an associated one of the first lateral side 18 and the second lateral side 20 of the base 12.

With reference to FIG. 7, the bias assembly 56 in another embodiment comprises a pair of torsion springs 66, each of which is coupled to the base 12 and an associated support arm 28 of the pair of support arms 28 of the cradle 22. A first spring arm 68 of each torsion spring 66 is received into an associated one of a pair of spring arm receivers 72 coupled to the cradle 22. Each spring arm receiver 72 is positioned on an associated support arm 28 of the pair of support arms 28 and slidably receives the first spring arm 68 of the associated torsion spring 66, thereby allowing the first spring arm 68 to urge the cradle 22 to pivot with respect to the base 12 while sliding with respect to the associated spring arm receiver 72.

The bias assembly 56 of the embodiment shown in FIG. 7 further includes a pair of loading plates 74 coupled to the base 12, each of which is positioned to forcibly engage a second spring arm 70 of an associated torsion spring 66 of the pair of torsion springs 66. Each loading plate 74 of the pair of loading plates 74 is pivotably adjustable to set an angle between the first spring arm 68 and the second spring arm 70 of the associated torsion spring 66, thereby preloading the associated torsion spring 66 when the cradle 22 is positioned in the central position 58.

The bias assembly 56 of the embodiment depicted in FIG. 7 further comprises a pair of angle adjustment screws 76, each of which is threadedly coupled to an associated loading plate 74 of the pair of loading plates 74. Each angle adjustment screw 76 is forcibly engaged to the base 12. Each angle adjustment screw 76 is rotatable in a first rotational direction to urge the associated loading plate 74 against bias of the associated torsion spring 66 and is rotatable in a second rotational direction opposite the first rotational direction to permit the associated loading plate 74 to move with bias of the associated torsion spring 66. The angle adjustment screws 76 may thus be operated to adjust a preloading torsion onto the associated torsion spring 66 when the cradle 22 is positioned in the central position 58.

Springs of the bias assembly 56 in either embodiment described and in other embodiments may be preloaded, which may assist the springs in remaining attached or engaged to the base 12 and the cradle 22 and may ensure the springs do not slacken such that the springs entangle with each other or with other components. Other types of springs, members comprising elastic materials, or the like may be used in the bias assembly 56.

A plurality of support assemblies 78 is coupled to the base 12 which may be used to adjust a seating of the base 12 atop a ground surface 96 or other support surface. Each support assembly 78 comprises a sleeve 80 coupled to the base 12 and a leg member 82 slidably mounted in the sleeve 80. The leg member 82 is slidable laterally to the base 12. The support assemblies 78 are positioned in opposing pairs such that the leg members 82 of the opposing pairs may extend outwardly from the base 12 and away from each other to expand a footprint of the base 12 atop the ground surface 96. The leg members 82 of the opposing pairs may be retracted into the sleeves 80 inwardly with respect to the base 12 and toward each other to collapse for storage or a smaller footprint of the base 12 atop the ground surface 96.

Each support assembly 78 further includes a locking member 86 for fixing a position of the leg member 82 with respect to the base 12. The locking member 86 comprises a set screw which extends through the sleeve 80 and is forcibly engageable with the leg member 82. The locking member 86 may comprise a locking pin, a clamp, a magnet, a detent, or the like in other embodiments. Each support assembly 78 also comprises a height adjustment member 88 coupled to the leg member 82 adjacent a distal end 84 of the leg member 82 with respect to the sleeve 80. The height adjustment member 88 is usable to set a height of the distal end 84 of the leg member 82 above the ground surface 96. The height adjustment member 88 is threadedly coupled to the leg member 82 and is rotatable in alternating rotational directions to alternately raise and lower the height adjustment member 88 with respect to the leg member 82. When the height adjustment member 88 is lowered with respect to the leg member 82, the height adjustment member 88 presses on the ground surface 96 to lift the distal end 84 of the leg member 82 above the ground surface 96. When the heigh adjustment member is raised with respect to the leg member 82, the height adjustment member 88 permits the distal end 84 of the leg member 82 to be lowered toward the ground surface 96.

In use, the motorcycle 90 may be mounted by a select one of the wheels 92 of the motorcycle 90 onto the cradle 22. The cradle 22 is sized and shaped to accommodate only one wheel 92 while another one of the wheels 92 of the motorcycle 90 rests atop the ground surface 96 during use. FIG. 1 depicts a usage of the training apparatus 10 in which a rear wheel 94 of the motorcycle 90 is mounted in the cradle 22 while a front wheel (not shown) of the motorcycle 90 may be allowed to rest atop the ground surface 96 and may be maneuvered by a user during use of the training apparatus 10 without interfering with the training apparatus 10. In some embodiments and use cases, however, the front wheel (not shown) of the motorcycle 90 may be allowed to mount in the cradle 22 while the rear wheel 94 rests atop the ground surface 96. In other embodiments, both the front wheel (not shown) and the rear wheel 94 may be mounted to the cradle 22.

With the selected wheel 92 mounted to the cradle 22, the user may sit astride the motorcycle 90 and practice leaning the motorcycle 90 alternately left and right of the user to simulate positioning of the motorcycle 90 which would similarly occur during driving the motorcycle 90 in a turning operation. Leaning the motorcycle 90 in this manner causes the cradle 22 to be urged away from the central position 58 alternately toward the first lateral side 18 and the second lateral side 20 of the base 12, which thereby causes the bias mechanism to react to resist such movement. In this manner, the bias mechanism helps prevent the user from falling over, thereby preventing injury to the user and damage to the motorcycle 90. The user may operate the training apparatus 10 in this way to practice moving the motorcycle 90 similar to how it would actually move while driving and turning the motorcycle 90, and to do so while the motorcycle 90 is not being propelled forwardly by a motor of the motorcycle 90.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A training apparatus for use with a motorcycle, the training apparatus comprising:
a base;
a cradle pivotably coupled to the base, the cradle being pivotable alternately toward a first lateral side and a second lateral side of the base, the cradle being shaped and configured to seat a wheel of the motorcycle; and
a bias assembly coupled to and extending between the cradle and the base, the bias assembly being configured to bias the cradle toward a central position with respect to the base, the cradle being pivotable against bias alternately toward the first lateral side and the second lateral side of the base from the central position.

2. The training apparatus of claim 1, wherein the cradle comprises:
a platform having an upper surface for supporting a wheel of the motorcycle, the upper surface having a concave shape; and
a pair of support arms coupled to the platform, the pair of support arms being positioned opposite each other across the platform, each support arm of the pair of support arms extending upwardly and outwardly from the platform.

3. The training apparatus of claim 2, wherein the cradle further comprises a mounting strap coupled to and extending between distal ends of the pair of support arms with respect to the platform, the mounting strap being configured to extend over the wheel of the motorcycle.

4. The training apparatus of claim 2, wherein:
each support arm of the pair of support arms of the cradle has a lower segment which extends under the platform, the lower segment of each support arm having a rocking surface opposite the platform which has a convex shape;
further comprising a plurality of rocking support members coupled to the base, each rocking support member of the plurality of rocking support members being positioned under an associated support arm of the pair of support arms of the cradle, the rocking surface of each support arm being positioned to rock over an associated rocking support member of the plurality of rocking support members when the cradle is pivoted.

5. The training apparatus of claim 4, wherein a top surface of each rocking support member is angled to extend upwardly from an inner edge to and outer edge of the rocking support member.

6. The training apparatus of claim 2, further comprising a pivot mechanism coupling the cradle to the base, the pivot mechanism comprising:
a pair of cylindrical rods coupled to the cradle on a lower side of the platform, each cylindrical rod of the pair of cylindrical rods extending between a front side and a back side of the base; and
a pair of rod receivers coupled to the base, each rod receiver of the pair of rod receivers having an associated cylindrical rod of the pair of cylindrical rods mounted therein, each rod receiver having an opening for receiving the associated cylindrical rod, each rod receiver of the pair of rod receivers having a pivot support surface which is complementary in shape to an exterior of the associated cylindrical rod.

7. The training apparatus of claim 1, further comprising a plurality of support assemblies coupled to the base, each support assembly of the plurality of support assemblies comprising:
a sleeve coupled to the base; and
a leg member slidably mounted in the sleeve, the leg member being slidable laterally with respect to the base.

8. The training apparatus of claim 7, wherein each support assembly of the pair of support assemblies further comprises a locking member for fixing a position of the leg member with respect to the base, the locking member comprising a set screw extending through the sleeve, the set screw being forcibly engageable with the leg member.

9. The training apparatus of claim 7, wherein each support assembly of the pair of support assemblies further comprises a height adjustment member coupled to the leg member adjacent a distal end of the leg member with respect to the sleeve, the height adjustment member being movable alternately upwardly and downwardly with respect to the base.

10. The training apparatus of claim 9, wherein the height adjustment member of each support assembly is threadedly coupled to the leg member.

11. The training apparatus of claim 1, wherein the bias assembly comprises a plurality of tension springs, a first end of each tension spring of the plurality of tension springs being coupled to the distal end of an associated support arm of the pair of support arms, a second end of each tension spring of the plurality of tension springs being coupled to the base adjacent to an associated one of the first lateral side and the second lateral side of the base.

12. The training apparatus of claim 1, wherein the bias assembly comprises a pair of torsion springs, each torsion spring being coupled to the base and an associated support arm of the pair of support arms of the cradle.

13. The training apparatus of claim 12, wherein the bias assembly further comprises a pair of spring arm receivers coupled to the cradle, each spring arm receiver of the pair of spring arm receivers being positioned on an associated support arm of the pair of support arms, each spring arm receiver slidably receiving a first spring arm of an associated torsion spring of the pair of torsion springs.

14. The training apparatus of claim 13, wherein the bias assembly further comprises a pair of loading plates coupled to the base and being positioned to forcibly engage a second spring arm of an associated torsion spring of the pair of torsion springs, each loading plate of the pair of loading plates being pivotably adjustable to set an angle between the first spring arm and the second spring arm of the associated torsion spring.

15. The training apparatus of claim 14, wherein the bias assembly further comprises a pair of angle adjustment screws, each angle adjustment screw of the pair of angle adjustment screws being threadedly coupled to an associated loading plate of the pair of loading plates, each angle adjustment screw of the pair of angle adjustment screws being forcibly engaged to the base, wherein each angle adjustment screw is rotatable in a first rotational direction to urge the associated loading plate against bias of the associated torsion spring and is rotatable in a second rotational direction opposite the first rotational direction to permit the associated loading plate to move with bias of the associated torsion spring.

16. A training apparatus for use with a motorcycle, the training apparatus comprising:
a base;
a cradle pivotably coupled to the base, the cradle being pivotable alternately toward a first lateral side and a second lateral side of the base, the cradle comprising:
a platform having an upper surface for supporting a wheel of the motorcycle, the upper surface having a concave shape;
a pair of support arms coupled to the platform, the pair of support arms being positioned opposite each other across the platform, each support arm of the pair of support arms extending upwardly and outwardly from the platform, each support arm of the pair of support arms having a lower segment which extends under the platform, the lower segment of each support arm having a rocking surface opposite the platform which has a convex shape; and
a mounting strap coupled to and extending between distal ends of the pair of support arms with respect to the platform, the mounting strap being configured to extend over the wheel of the motorcycle;
a pivot mechanism coupling the cradle to the base, the pivot mechanism comprising:
a pair of cylindrical rods coupled to the cradle on a lower side of the platform, each cylindrical rod of the pair of cylindrical rods extending between a front side and a back side of the base; and
a pair of rod receivers coupled to the base, each rod receiver of the pair of rod receivers having an associated cylindrical rod of the pair of cylindrical rods mounted therein, each rod receiver having an opening for receiving the associated cylindrical rod, each rod receiver of the pair of rod receivers having a pivot support surface which is complementary in shape to an exterior of the associated cylindrical rod;
a bias assembly coupled to and extending between the cradle and the base, the bias assembly being configured to bias the cradle toward a central position with respect to the base, the cradle being pivotable against bias alternately toward the first lateral side and the second lateral side of the base from the central position;
a plurality of rocking support members coupled to the base, each rocking support member of the plurality of rocking support members being positioned under an associated support arm of the pair of support arms of the cradle, the rocking surface of each support arm being positioned to rock over an associated rocking support member of the plurality of rocking support members when the cradle is pivoted, a top surface of each rocking support member being angled to extend upwardly from an inner edge to and outer edge of the rocking support member; and
a plurality of support assemblies coupled to the base, each support assembly of the plurality of support assemblies comprising:
a sleeve coupled to the base;
a leg member slidably mounted in the sleeve, the leg member being slidable laterally with respect to the base;
a locking member for fixing a position of the leg member with respect to the base, the locking member comprising a set screw extending through the sleeve, the set screw being forcibly engageable with the leg member; and
a height adjustment member coupled to the leg member adjacent a distal end of the leg member with respect to the sleeve, the height adjustment member being movable alternately upwardly and downwardly with respect to the base, the height adjustment member being threadedly coupled to the leg member.

17. The training apparatus of claim 16, wherein the bias assembly comprises a plurality of tension springs, a first end of each tension spring of the plurality of tension springs being coupled to the distal end of an associated support arm of the pair of support arms, a second end of each tension spring of the plurality of tension springs being coupled to the base adjacent to an associated one of the first lateral side and the second lateral side of the base.

18. The training apparatus of claim 16, wherein the bias assembly comprises:
a pair of torsion springs, each torsion spring being coupled to the base and an associated support arm of the pair of support arms of the cradle;
a pair of spring arm receivers coupled to the cradle, each spring arm receiver of the pair of spring arm receivers being positioned on an associated support arm of the pair of support arms, each spring arm receiver slidably receiving a first spring arm of an associated torsion spring of the pair of torsion springs;
a pair of loading plates coupled to the base and being positioned to forcibly engage a second spring arm of an associated torsion spring of the pair of torsion springs, each loading plate of the pair of loading plates being pivotably adjustable to set an angle between the first spring arm and the second spring arm of the associated torsion spring; and
a pair of angle adjustment screws, each angle adjustment screw of the pair of angle adjustment screws being threadedly coupled to an associated loading plate of the pair of loading plates, each angle adjustment screw of the pair of angle adjustment screws being forcibly engaged to the base, wherein each angle adjustment screw is rotatable in a first rotational direction to urge the associated loading plate against bias of the associated torsion spring and is rotatable in a second rotational direction opposite the first rotational direction to permit the associated loading plate to move with bias of the associated torsion spring.
